(19) United States
(12) Patent Application Publication
(10) Pub. No.: US 2009/0113278 A1
(43) Pub. Date: Apr. 30, 2009

(54) SYSTEM AND METHODS FOR GENERATING AUTOMATIC AND USER-CONTROLLABLE MOVIES OF PRESENTATIONS ON SMALL DEVICES

(75) Inventors: Laurent DENOUE, Palo Alto, CA (US); Patrick CHIU, Menlo Park, CA (US); Tohru FUSE, Kanagawa (JP); Yukiyo UEHORI, Tokyo (JP)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/924,554

(22) Filed: Oct. 25, 2007

(51) Int. Cl. G06F 3/14

(52) U.S. Cl. 715/201

(57) ABSTRACT

Presentations, tutorials and screencasts are difficult to watch on a small device such as a cell phone because the screen is too small to properly render content that typically contains text, like a presentation slide or a screenshot. The described system facilitates generating a user-controllable video movie from an existing media stream that 1) automatically identifies regions of interest from the original stream using visual, auditory and meta streams, 2) synchronizes these regions of interest with the original media stream, and 3) uses panning and scanning to zoom in and out or move the focus. The generated time-based media stream can be seamlessly interrupted by users, letting them temporarily focus on specific regions of interest. Meanwhile, the original media stream can continue playing or instead jump around the timeline as users jump between regions of interest.

### FIELD OF THE INVENTION

The present invention generally relates to techniques for generating and presenting content, including multimedia content, and more specifically, to a system and accompanying methods for automatically generating a video or other multimedia recording that automatically focuses on parts of the presented content that may be of particular interest to the user at a specific time.

### DESCRIPTION OF THE RELATED ART

Recorded presentations, lectures and tutorials such as screencasts are hard to watch on a small screen of a mobile device, such as a cellular phone or a PDA. A typical computer screen shows presentations at a resolution of at least 800×600 pixels, while a typical screen of a cellular phone has resolution of only 240×160 pixels. Even if the resolution of the screen is increased (newer models like Apple's iPhone boost 320×480 pixels), the actual physical size of a cell phone screen is likely to remain substantially small because people like portable and small devices. Thus, a problem remains of how to use the scarce real estate of a cell phone screen to convey maximum information to the user with the highest efficiency.

Several authors have attempted to address this problem in the past. For example, in Wang, et al., MobiPicture: browsing pictures on mobile devices, Proceedings of the eleventh ACM international conference on Multimedia, Berkeley, Calif., USA, Pages: 106-107, 2003, the authors propose a technique that shows regions of interest computed over a picture such as a photograph of people. The system then only crops the photograph around faces that have been detected, and shows all faces in sequence.

In Erol et al., Multimedia thumbnails for documents, Proceedings of the 14th annual ACM international conference on Multimedia, Santa Barbara, Calif., USA, Pages: 231-240, 2006, the authors proposed to automatically analyze the document layout of PDF files to determine what areas are most likely to be of interest to the user. For example, a figure on a page will be found as relevant and focused. The described system also uses text to speech recognition to read out loud the caption of the figure.

In another example, in Harrison et al., Squeeze Me, Hold Me, Tilt Me! An Exploration of manipulative user interfaces, Proceedings of CHI '98, pp. 17-24, the authors describe a system, wherein a mobile device uses tilt sensors to sequentially navigate a list in a document, using a Rolodex metaphor. However, the described technique is limited to pure sequential browsing of a list and, therefore, has limited applicability to other presentation contexts, wherein the presentation flow may be non-linear.

Thus, the existing technology fails to provide an effective solution for the problem associated with providing the user with the most relevant, at specific point in time, content using a small presentation device.

### SUMMARY OF THE INVENTION

The inventive methodology is directed to methods and systems that substantially obviate one or more of the above and other problems associated with conventional techniques for presentation of content to the user.

In accordance with one aspect of the inventive concept, there is provided a computer-implemented method involving: capturing at least a portion of a presentation given by a presenter; capturing at least a portion of actions of the presenter; using the captured actions of the presenter to analyze and identify a sequence of regions of interest in the presentation; using the captured actions of the presenter to identify the temporal path of the presentation; and composing a focused timed content representation of the presentation based on the identified sequence of regions of interest in the presentation and the identified the temporal path of the presentation. The composed focused timed content representation focuses on the identified regions of interest in the presentation.

In accordance with another aspect of the inventive concept, there is provided a computer-readable medium embodying a set of instructions, which, when executed by one or more processors cause the one or more processors to perform a method involving: capturing at least a portion of a presentation given by a presenter; capturing at least a portion of actions of the presenter; using the captured actions of the presenter to analyze and identify a sequence of regions of interest in the presentation; using the captured actions of the presenter to identify the temporal path of the presentation; and composing a focused timed content representation of the presentation based on the identified sequence of regions of interest in the presentation and the identified the temporal path of the presentation. The composed focused timed content representation focuses on the identified regions of interest in the presentation.

In accordance with another aspect of the inventive concept, there is provided a computerized system including a capture module operable to capture at least a portion of a presentation given by a presenter and capture at least a portion of actions of the presenter; a presentation analysis module operable to use the captured actions of the presenter to analyze and identify a sequence of regions of interest in the presentation and to use the captured actions of the presenter to identify the temporal path of the presentation; and a video authoring module operable to compose a focused timed content representation of the presentation based on the identified regions of interest in the presentation and the identified the temporal path of the presentation. The composed focused timed content representation focuses on the identified regions of interest in the presentation.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of the inventive system and the constituent components thereof.

FIG. 2 illustrates an exemplary operating sequence of an embodiment of the inventive system.

FIG. 3 illustrates an exemplary operation result of an embodiment of the inventive system.

FIG. 4 illustrates another exemplary operation result of an embodiment of the inventive system.

FIG. 5 illustrates yet another exemplary operation result of an embodiment of the inventive system in a context of presentation incorporating a bar graph.

FIG. 6 illustrates an exemplary operation result of an embodiment of the inventive system in a context of a presentation chart that includes a set of single-directional arrows.

FIG. 7 illustrates an exemplary operation result of an embodiment of the inventive system in a context of a presentation chart that includes a set of mixed-directional arrows.

FIG. 8 illustrates an exemplary operation result of an embodiment of the inventive system in a context of a presentation table, which consists of 4 by 8 columns.

FIG. 9 illustrates an exemplary embodiment of the inventive system utilizing a tilt of the user's mobile device to focus on regions of interest to the user.

FIG. 10 illustrates an exemplary embodiment of the inventive system utilizing a hand gesture motion to help generate the Pan-and-Scan movie.

FIG. 11 illustrates an exemplary embodiment of the inventive system utilizing marks or annotation on the slide to help generate the Pan-and-Scan movie.

FIG. 12 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

As stated above, presentations, tutorials and screencasts are difficult to watch on a small device such as a cell phone because the screen may be too small to properly render content that typically contains text, like a presentation slide or a screenshot. To address this problem, an embodiment of the inventive technique facilitates generating a user-controllable video movie from an existing media stream that 1) automatically identifies regions of interest from the original stream using visual, auditory and meta streams, 2) synchronizes these regions of interest with the original media stream, and 3) uses panning and scanning to zoom in and out or move the focus. The generated time-based media stream can be seamlessly interrupted by users, letting them temporarily focus on specific regions of interest. Meanwhile, the original media stream can continue playing or instead jump around the timeline as users jump between regions of interest.

An embodiment of the inventive system facilitates automatic generation of a video or other multimedia recording that automatically focuses on parts of the presented content that may be of particular interest to the user at a specific time. Specifically, one embodiment of the inventive system uses panning and scanning as the two main techniques to automatically (or upon user's request) focus to specific elements in the media stream, as will be described in detail below.

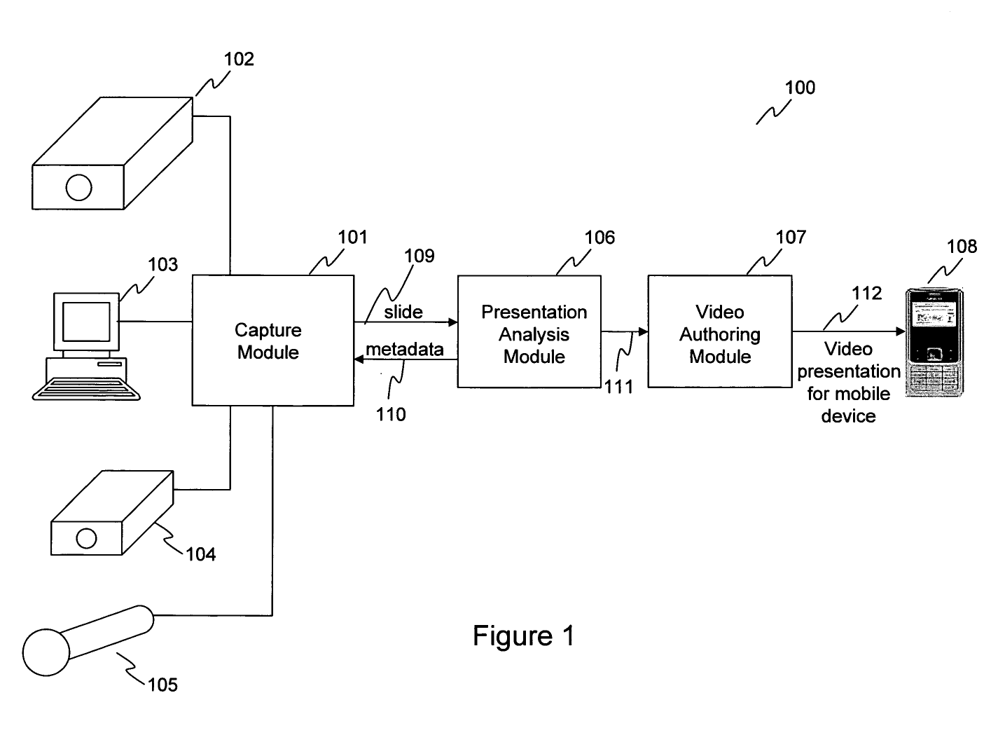

FIG. 1 illustrates an exemplary embodiment 100 of the inventive system and the constituent components thereof. The shown embodiment of the inventive system may incorporate a capture module 101, which may capture multimedia presentations and other content using various devices, which may include, without limitation, a projector 102, a presenter's computer 103, a video or still image camera 104 and/or a microphone 105. In various embodiments of the invention, a media stream can be a video of a lecture, where frames are sometimes showing the slides full-screen with the presenter moving and gesturing in front, or a set of synchronized streams such as jpeg pictures and mp3 files as captured by systems like ProjectorBox. Another exemplary setup is a room equipped with multiple cameras that detect and track the presenter's interactions with the slides on the room display, plus other capture appliances to record the slides and audio. All such presentation modes are capable of being captured by the capture module 101 and the associated capture devices 102-105.

The capture module 101 then transmits the captured presentation slides, captured audio and/or other content 109 as well as associated metadata 110 to a presentation analysis module 106. The presentation analysis module 106, in turn, uses audio and visual features to find synchronized regions of interest, which are the regions in the complete original presentation that appear to be relevant to the user at a particular point in time, from the point of view of presentation flow.

The information 111 generated by the presentation analysis module 106, which includes the information on the aforesaid synchronized regions of interest is passed to the video authoring module 107, which generates a movie or other timed focused multimedia content 112 that provides the user with a focused and properly synchronized view of the presentation and is designed for user's presentation device having a small size to convey to the user the most relevant regions in the entire original presentation at a particular point in time of the presentation flow. The movie or other timed focused multimedia content 112 may also include the accompanying sound portion of the presentation.

Finally, this generated movie or other focused multimedia content 112 is provided to a user's presentation device 108, which can be a mobile device, such as PDA, cellular phone, such as iPhone by Apple Inc., or any other suitable apparatus on which the generated movie or other focused multimedia content 112, including the accompanying sound, may be effectively presented to the user.

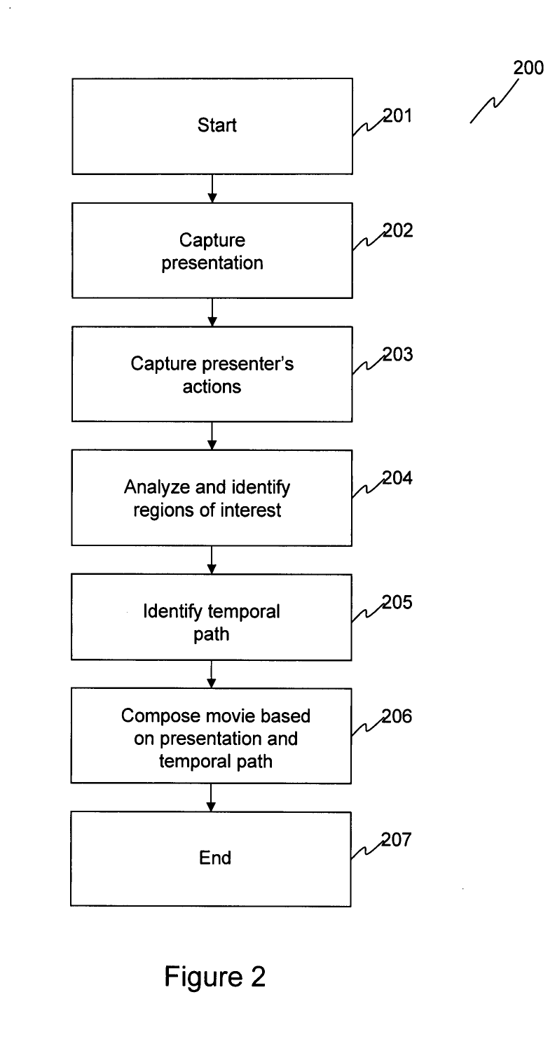

FIG. 2 illustrates an exemplary operating sequence 200 of an embodiment of the inventive system, such as the embodiment 100 shown in FIG. 1. The operation of the embodiment 100 starts at step 201. At step 202, the presentation is captured. At step 203, the actions of a person who makes the presentation are captured as well. At step 203, the presentation analysis module 106 analyses the captured presentation and identifies regions of interest, relevant, from the point of view of the presentation flow at a specific point in tome. This temporal path of the presentation is identified by the presentation analysis module at step 205. The video authoring module 107 at step 206 generates a movie or other timed focused content 112 based on the analyzed presentation, its temporal path and regions of interest, whereupon the operation concludes at step 207. It should be noted that the above operating sequence may also include transferring the movie or other timed focused content 112 to the mobile or other presentation device of the user and presenting the transferred media to the user. These steps may be performed using any known technique and, therefore, the exact manner of accomplishing these operations is not critical to the present invention. Thus, those steps are not illustrated in FIG. 2.

By default, the embodiment of the inventive system shown in FIG. 1 is operating in an automatic mode: the system 100 plays back the original or re-indexed video stream but zooms into the regions of interest at the right time, and then zooms back to show the full screen of the slides. When appropriate, the system also uses scanning to show nearby regions of interest. For example, if a word found on the slide using the optical character recognition (OCR) is found in the audio stream at minute 2′30″, the system will zoom in to show with word at minute 2′30 and will pan the rest of the line where the word was found. Thus an embodiment of the inventive system may include an OCR functionality to perform the aforementioned optical character recognition (OCR) of words found in the audio stream.

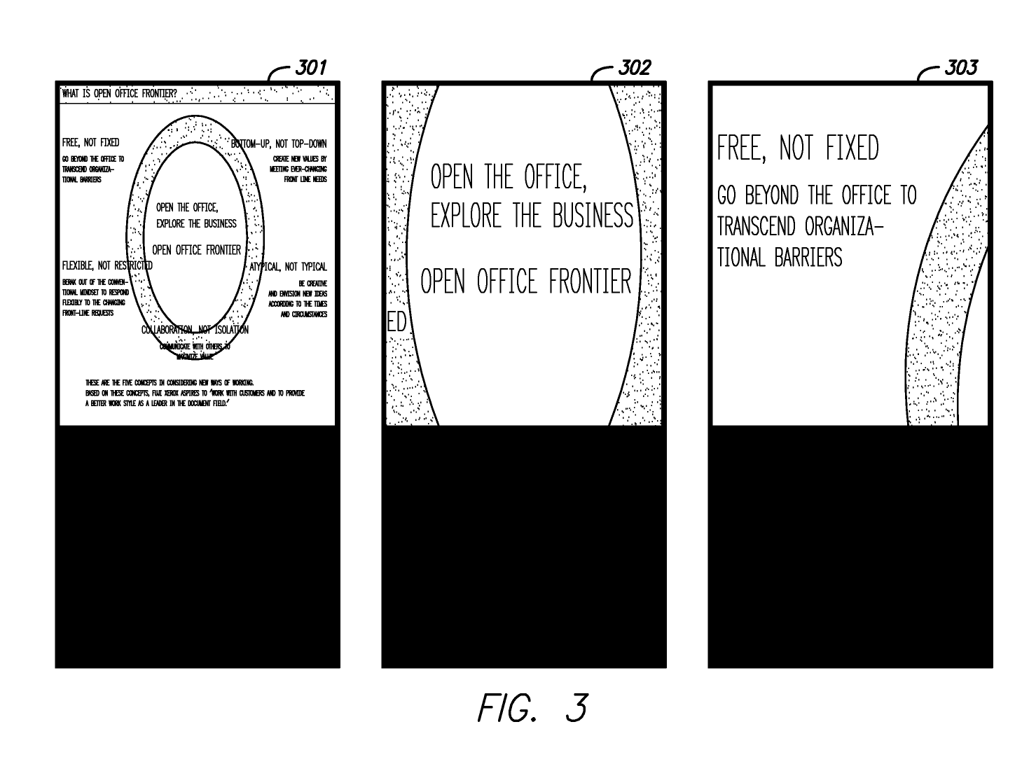

FIG. 3 illustrates an exemplary operation result of an embodiment of the inventive system. This figure illustrates that with automatic pans and scans for slides, generated by an embodiment of the present invention, the user are shown regions of interest in slides in a way that is synchronized in time with gestures of the presenter and the audio features of the presentation captured by the capture devices 102-105. For example, focused portions 302-303 of the same presentation slide 301, which are shown to the user in accordance with the explanations of provided by the presenter. That is, when the presenter describes item(s) located at a particular portion of the slide, the inventive system automatically focuses on the described component and zooms into the appropriate regions of the slide 302-303. To accomplish this, an embodiment of the inventive system compares terms obtained using voice recognition of the presentation audio with the terms found in the presentation slide, which may be extracted using the OCR of directly extracted from the presentation file. If the match or a sufficiently close match is found, the system performs the appropriate zoom operation(s). The system may take into account that fact that the presenter may not use the exact term appearing in the presentation, but may use other terms, such as synonyms. Thus, the system may check for synonym words or use other indications that the current point in the presentation time flow is related to a specific item in the presentation. For example, the inventive system may detect the presenter's use of a pointing device, such as a laser pointer.

In one embodiment of the invention, at any given time during playback, users can take control and manually go to the next region of interest independently of the general timeline of the presentation. For example, if the user is interested in reading more about a term, person, picture or some other portion of the presentation, he can press the device's navigation keys (or tilt the device) to jump to the next or previous region of interest. On a slide, regions of interest may include words as extracted by OCR or using other extraction methods, such as file extraction methods (e.g. PowerPoint can extract word bounding boxes of PPT files) and images. On a cell phone, the navigation keys can be up, down, right, left, which are mapped to going to the previous line, next line, next word or previous word on the slide.

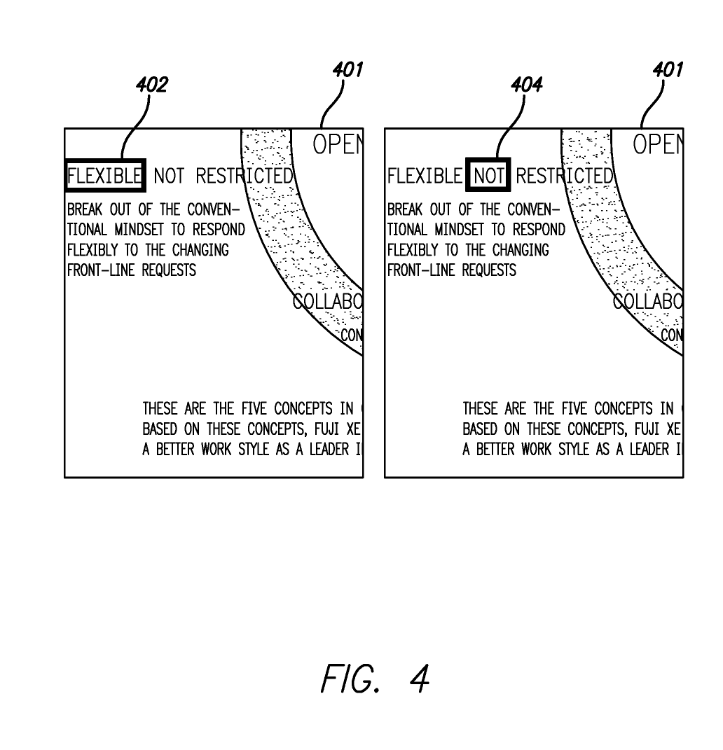

When users enter the manual navigation mode, the current point in focus becomes the currently selected focus from which the user can start navigating. For example in FIG. 4, which illustrates another exemplary operation result of an embodiment of the inventive system, if the system was zoomed in to the word “Real” 402 in the presentation slide 401 and the user takes control, then if the user presses “next”, the system then focuses on the word “object” 404 in the same slide 401 because it is the next region of interest found by the system, which may be found using the aforesaid OCR functionality. If the system was not zoomed in to a specific region of interest when the user takes control, then the first region of interest on that slide (e.g. the first top/left word as found by the OCR) becomes the focus. A seamless transition happens by zooming into this area.

Similarly, when users exit the manual control, an embodiment of the inventive system transitions back into the automatic playback using zoom out, full view and zoom in to the next region of interest that was scheduled to be shown in focus.

### Pan-and-Scan for Graphs, Charts, Tables

Graphs, charts, and tables are common in presentations. These objects can be extracted by the presentation capture module 101 in many different ways. If the user is using PowerPoint software by Microsoft, the objects can be extracted through PowerPoint's application programming interface (API). If the user embedded the graph/chart as an object from another application, then the object's data can be obtained from Excel or other ActiveX controls. If the object is a plain image, then image analysis techniques, including the OCR, must be applied.

### Graphs

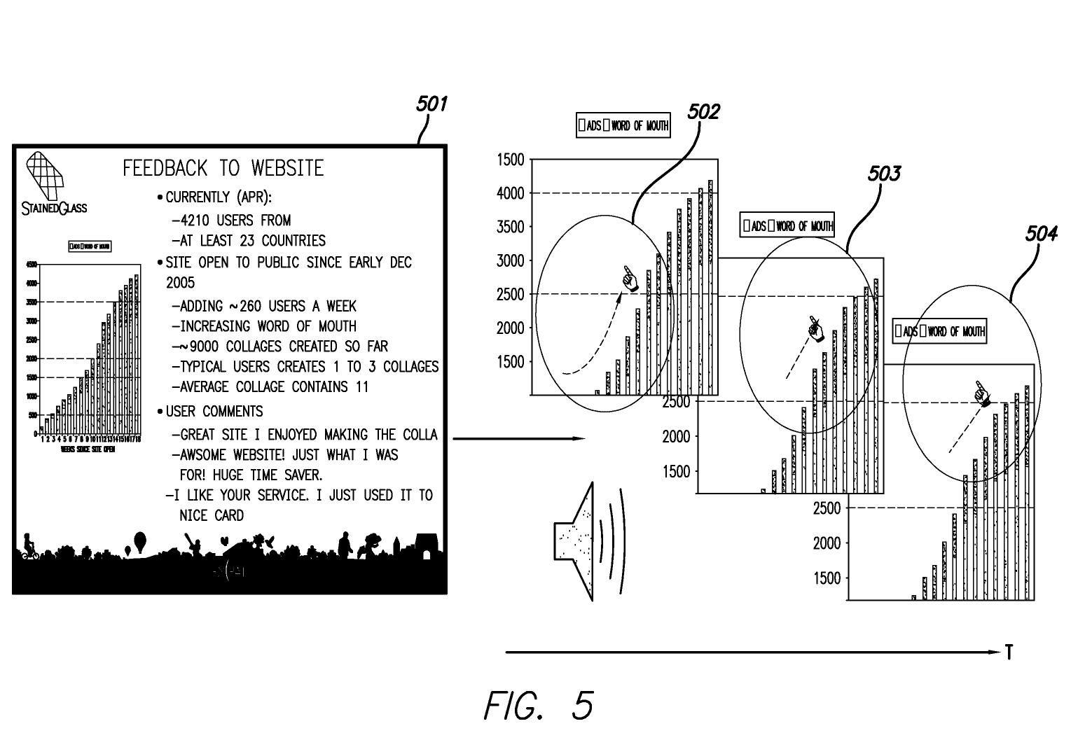

FIG. 5 illustrates another exemplary operation result of an embodiment of the inventive system in a context of presentation 501 incorporating a bar graph. As shown in this figure, for bar graphs, the pan-and-scan path 502-504 can follow along the contour of the top of the bar graph.

### Charts

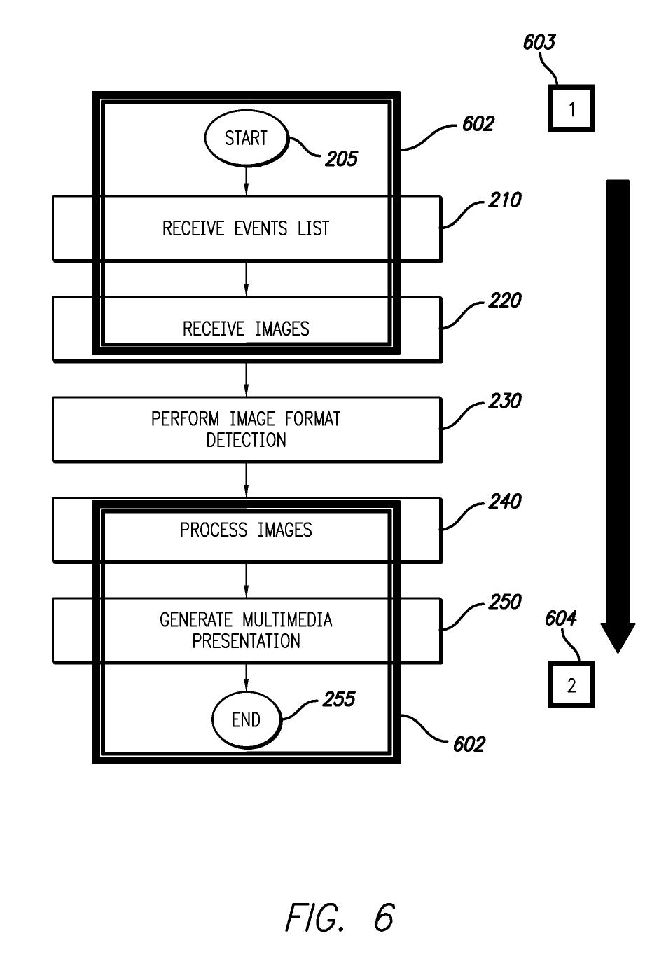

FIG. 6 illustrates an exemplary operation result of an embodiment of the inventive system in a context of a presentation chart that includes a set of directional arrows. An embodiment of the present invention includes a novel technique to pan charts, which include arrows. It should be noted that there may be two types of arrow configurations, one having the arrows pointing along a single direction and the other one having arrows point along mixed directions. The aforesaid FIG. 6 shows a chart that includes a set of single-directional arrows. Each arrow in the chart indicates a mono-direction. Accordingly, an embodiment of the inventive system would pan according to the direction, indicated by the arrows, see pan windows 601-604 shown in FIG. 6.

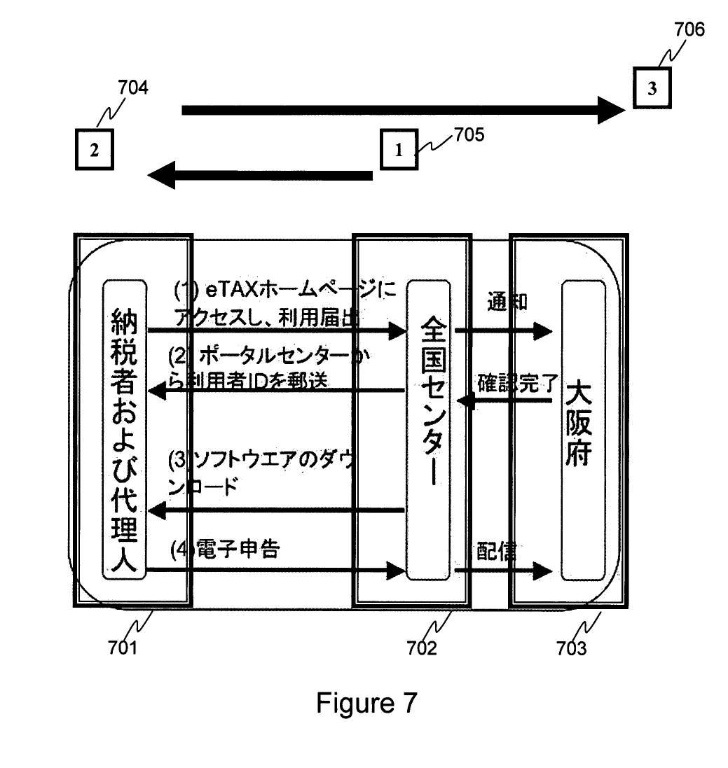

FIG. 7 illustrates an exemplary operation result of an embodiment of the inventive system in a context of a presentation chart that includes a set of mixed-directional arrows. Pan animation would start from the center box (702, 705), which has the largest number of input arrows. The slide would pan from the center box (702, 705) to the left box (701, 704), which has 2 input arrows and 2 output arrows, and then finally the slide would pan to the right box (703, 706) which has 2 input arrows and 1 output arrows. Thus, an embodiment of the invention uses a basic strategy of panning the charts, wherein arrows are used to rate the regions of interest based on the number of connections between other elements in the chart.

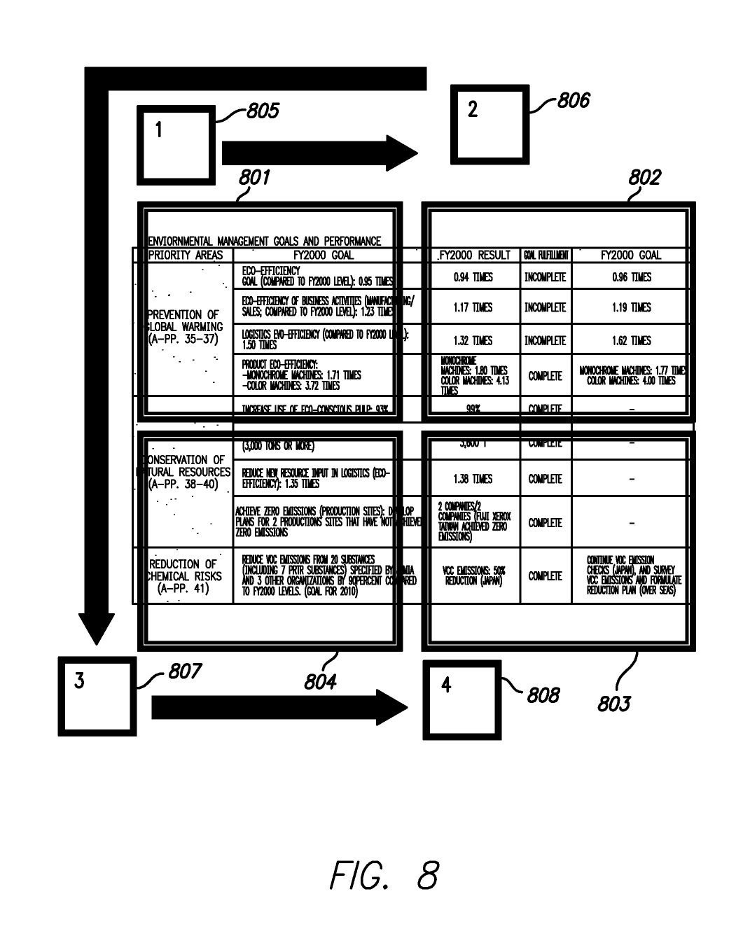

FIG. 8 illustrates an exemplary operation result of an embodiment of the inventive system in a context of a presentation table, which consists of 4 by 8 columns. Pan animation would start from the title (801, 805) and move horizontally to box (802, 806), and then the panning area would move vertically to box (803, 808). Finally the panning area would move to the lower right portion of the table (804, 807). In other words, an embodiment of the inventive system uses the strategy of panning the charts of table by skimming the table along the title and articles.

### Using Tilt Sensors to Navigate Regions of Interest

In accordance with another embodiment of the invention, the system uses mobile devices and cellular phones equipped with motion sensors for user input. For example, a new FOMA phone from NTT DoCoMo has motion sensors, as described by Tabuchi, “New Japanese Mobile Phones Detect Motion”, ABC News online, Apr. 25, 2007, http://abcnews.go.com/Technology/wireStory?id=3078694 (viewed 2007 Jun. 19). It is also possible to use the cellular phone's camera to estimate motion, as is done in the TinyMotion system described by Wang, et al., Camera Phone Based Motion Sensing: Interaction Techniques, Applications and Performance Study, In ACM UIST 2006, Montreux, Switzerland, Oct. 15-18, 2006.

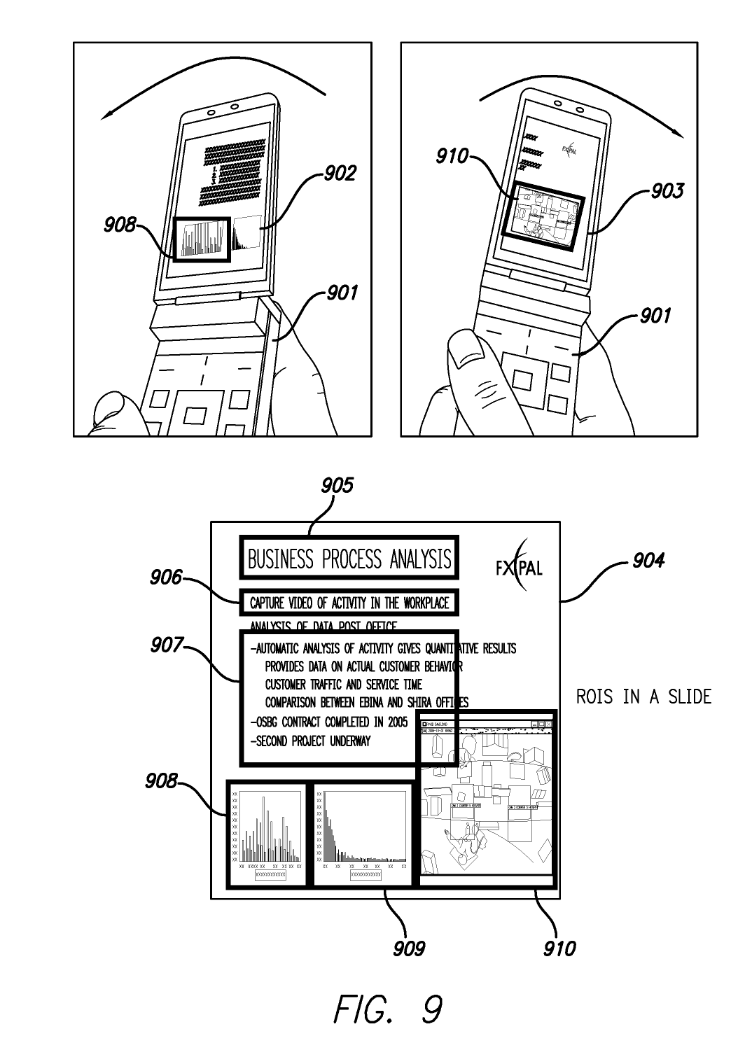

Using these techniques, the inventive system utilizes a novel way to navigate the region of interests. The interaction is very intuitive; the user simply tilts the device toward the region of interest that she wishes to view, as illustrated in FIG. 9. Specifically, FIG. 9 illustrates an exemplary embodiment of the inventive system utilizing a hand gesture motion to help generate the Pan-and-Scan movie. In that Figure, the user utilizes motion of the device 901 to help control playback of regions interest 905-910 in the slide 904. The particular regions of interest focused on by the inventive system are selected based on the rotational position of the device. For example, when the device 901 is rotated clockwise as to a position 903, the region of interest 910, appearing in the bottom right corner is focused on the inventive system. When the device 901 is turned counterclockwise into position 902, the region of interest 908, located at the bottom left corner is focused on.

It should also be noted that at least one embodiment of the inventive technique for finding the regions of interest described above is non-linear, as distinguished from the system described in the aforementioned Harrison et al., Squeeze Me, Hold Me, Tilt Me! An Exploration of manipulative user interfaces. Proceedings of CHI '98, pp. 17-24, wherein a mobile device uses tilt sensors to sequentially navigate a list in a document, using a Rolodex metaphor.

### Technical Details—Finding Synchronized Regions of Interest

In another embodiment of the invention, regions of interest can be found using information obtained from several input sources: video files (e.g. Google video of a recorded lecture), pbox-like devices, or PowerPoint slides. For video files, the system detects slides as unit elements using frame differencing. The original video is thus segmented into units of time, each having a representing slide and associated audio segment. The system then finds regions of interest on each unit (i.e. slide) using Optical Character Recognition, word bounding box and motion regions (e.g. a video clip playing within a slide or an animation). Speech to text is also used to link some regions of interest with words that might have been recognized in the audio stream.

For pbox-like devices, the input consists of already segmented slides with accompanying audio segments. The same process is applied. For PowerPoint files, the system extracts slides and uses the Document Object Model to extract regions of interest such as words, images, charts and media elements such as video clips if present. Since time information is not available, the system arbitrarily associates a time span with each slide based on the amount of information presented in that slide. If animations are defined for this slide, their duration is factored in. In the preferred embodiment, one line of text or a picture each count for 3 seconds.

### Detect and Track Presenter's Interactions Over the Slide

In another embodiment of the inventive system, the presenter's interactions over a slide are used to help detect active regions of interest and help compute the paths. Interactions include but not limited to: hand gestures, laser pointer gestures, cursor movement, marks, and annotations. Hand gesturing over a slide is quite common practice; in an informal test, we observed five talks during a week and four speakers gestured over the slide and one speaker used a laser pointer.

In an embodiment of the inventive system, interactions in front of the display can be extracted by differencing the snapshots of the display. Cursor movement, marks, and annotations can be obtained more precisely from PowerPoint or using APIs of the operating system of the presenter's computer system 103.

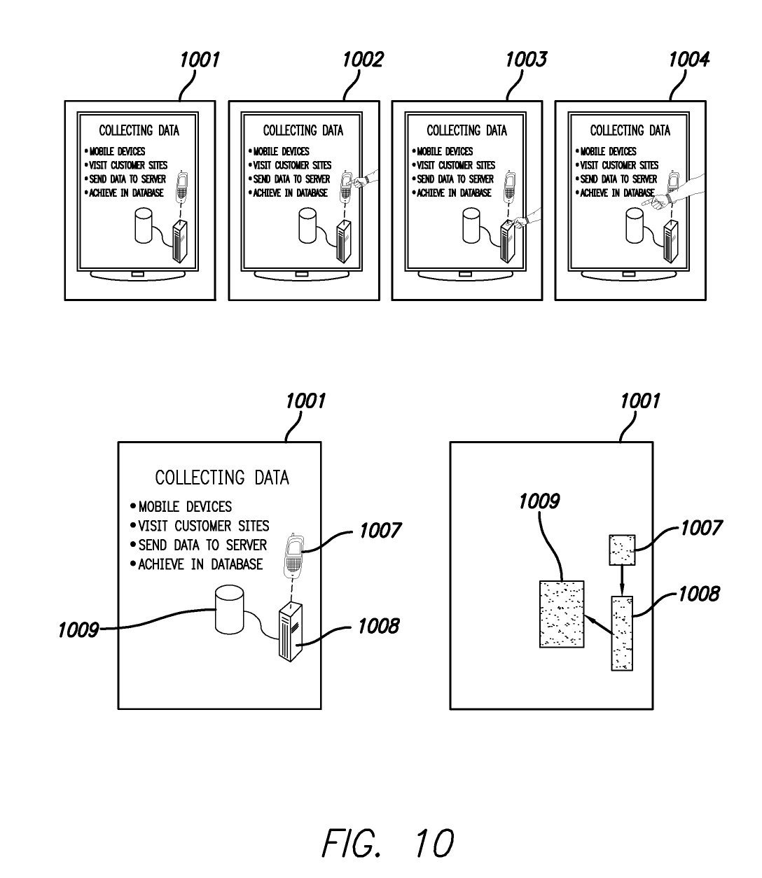

FIG. 10 illustrates an exemplary embodiment of the inventive system utilizing a hand gesture motion to help generate the Pan-and-Scan movie. In that example, in the consecutive images 1002-1004, the presenter points, using hand gestures, at the elements 107-109, respectively, of the presentation slide 1001. The embodiment of the inventive system detects the aforesaid hand gestures of the presenter and consecutively focuses on the on the same regions of interest 107-109 of the presentation slide, such that the aforesaid focusing operation performed by and embodiment of the inventive system is synchronized with the time flow of the presentation.

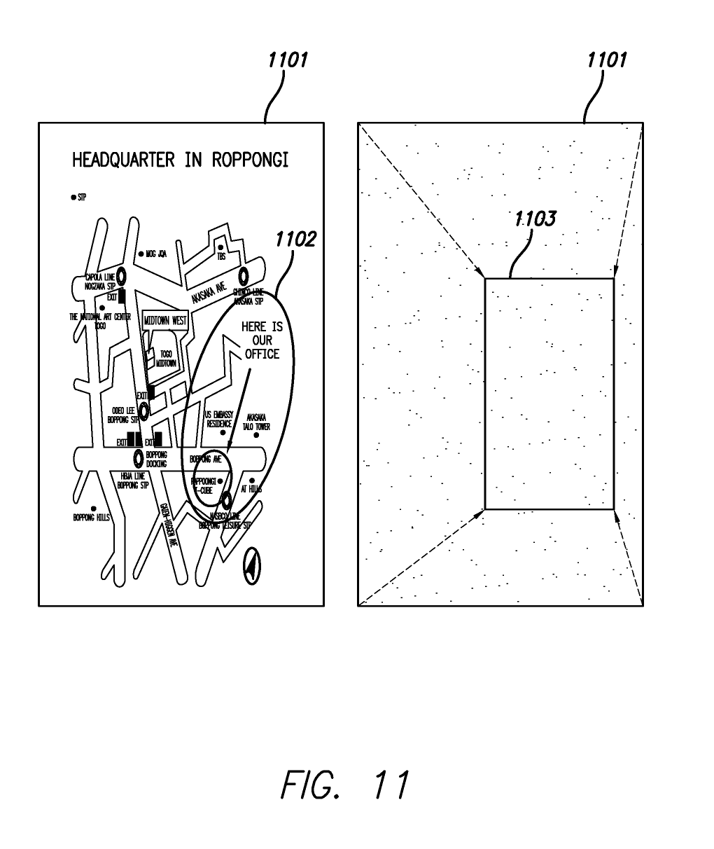

FIG. 11 illustrates an exemplary embodiment of the inventive system utilizing marks or annotation on the slide to help generate the Pan-and-Scan movie. In this embodiment, the inventive system detects the presenter's annotation 1102, which the presenter makes on the presentation slide 1101 during the presentation. In accordance with such detection, the region of interest 1103, containing the aforesaid annotation is being focused on by the inventive system.

### Transitioning Between Regions of Interest

Once the original stream has been segmented into units and regions of interest have been found on each unit, the video authoring module 107 of an embodiment of the inventive system automatically generates an animation to transition between these units and between regions of interest within each unit. Each unit corresponds to a time span (e.g. a slide is shown for 30 seconds). If mappings between the ROIs and the timeline are available, these are used to directly focus the zoom in/out and panning animations at the right times during playback.

Otherwise, zooming and scanning animations are set to match the number and locations of the regions of interest. For example, if five lines of text were detected and the duration of that segment is 30 seconds, then the algorithm zooms into the first word of the first line, scans across the line during 30/5−1 seconds, scans to the second line in one second, etc. until the last line is shown.

### Transitioning Between Automatic and Manual Modes

At any time, the user can interrupt the automatic playback and manually jump to different regions of interest using any available controller such as buttons on the device, tilt detectors or touch screens. In one mode, the audio track continues playing and when the user exits the manual navigation mode, the automatic playback resumes to where it would have been at that time, transitioning visually using zoom in/out or scanning.

### Application Scenarios—Watching a Video Lecture

Various application scenarios of various embodiments of the inventive system will now be described. In a first example, a student in Japan commutes by train. He finds an interesting video about MySQL database optimization on Google Video. Using the system, he can watch the recording without having to interact: the system automatically segmented the original video stream to show slides, and within slides, the system automatically zooms in and out at the right times (e.g. synchronized with gestures of the speaker and his speech). An interesting line appears on the slide, which is not found by the system as a region of interest. The student presses “next” on his cell-phone, which brings him into the manual control mode. It zooms in to the current region of interest. After he comes back home, he wants to try the optimization techniques out. Using an embodiment of the inventive system on his PC, he can browse the region of interests for both the system automatically found and the user found in the manual control mode.

### Watching an Annotated PowerPoint

In a second example, an office worker receives an email with an attached Power Point presentation that has been marked up with comments and freeform annotations. While walking, the user can watch a playback of the Power Point where an embodiment of the inventive system automatically pages through the document and zooms in and out of regions of interest, in this case the areas on each slide where annotations were created.

### Browsing Video Lectures

In another example, a student wants to find courses to take in the next semester. He accesses to his university's open courseware served by Knowledge Drive. Using the system, he can browse the highly rated slides based on teachers' intention (e.g. gestures, annotations) and students' collaborative attention (e.g. note-taking, bookmarking). The student shakes his cell-phone, which skips one video to another. In the manual control mode with the built-in motion sensor, a region of interest can be selected by tilting cell-phone.

### Exemplary Computer System

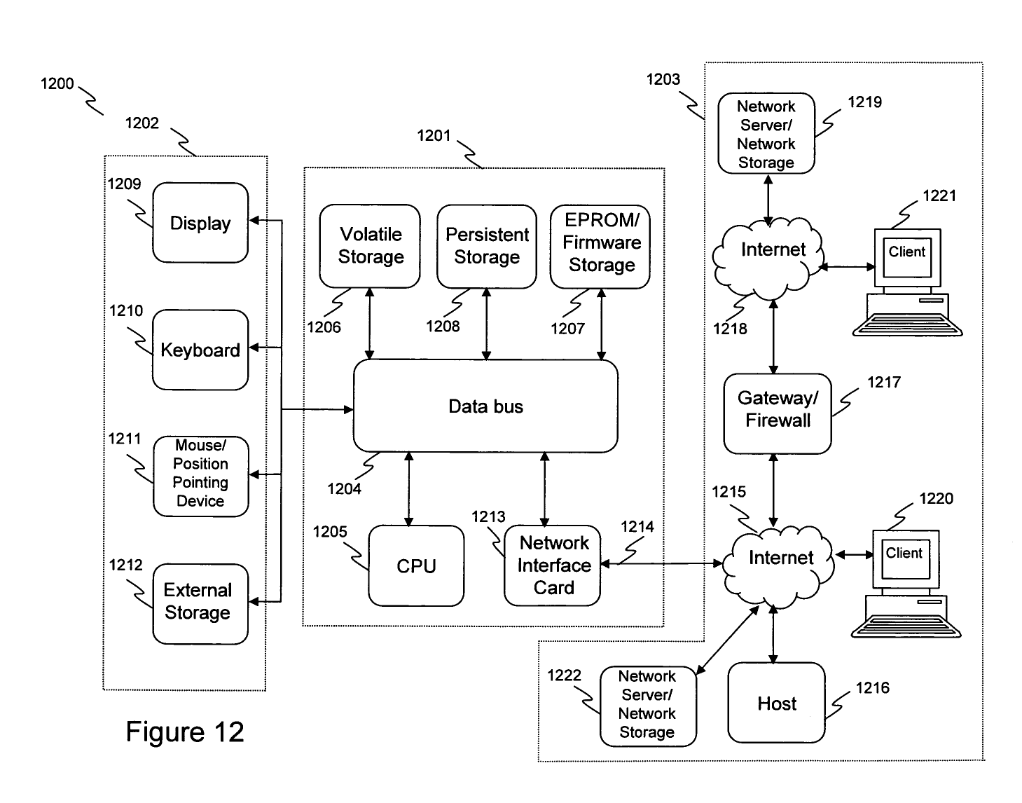

FIG. 12 is a block diagram that illustrates an embodiment of a computer/server system 1200 upon which an embodiment of the inventive methodology may be implemented. The system 1200 includes a computer/server platform 1201, peripheral devices 1202 and network resources 1203.

The computer platform 1201 may include a data bus 1204 or other communication mechanism for communicating information across and among various parts of the computer platform 1201, and a processor 1205 coupled with bus 1201 for processing information and performing other computational and control tasks. Computer platform 1201 also includes a volatile storage 1206, such as a random access memory (RAM) or other dynamic storage device, coupled to bus 1204 for storing various information as well as instructions to be executed by processor 1205. The volatile storage 1206 also may be used for storing temporary variables or other intermediate information during execution of instructions by processor 1205. Computer platform 1201 may further include a read only memory (ROM or EPROM) 1207 or other static storage device coupled to bus 1204 for storing static information and instructions for processor 1205, such as basic input-output system (BIOS), as well as various system configuration parameters. A persistent storage device 1208, such as a magnetic disk, optical disk, or solid-state flash memory device is provided and coupled to bus 1201 for storing information and instructions.

Computer platform 1201 may be coupled via bus 1204 to a display 1209, such as a cathode ray tube (CRT), plasma display, or a liquid crystal display (LCD), for displaying information to a system administrator or user of the computer platform 1201. An input device 1220, including alphanumeric and other keys, is coupled to bus 1201 for communicating information and command selections to processor 1205. Another type of user input device is cursor control device 1211, such as a mouse, a trackball, or cursor direction keys for communicating direction information and command selections to processor 1204 and for controlling cursor movement on display 1209. This input device typically has two degrees of freedom in two axes, a first axis (e.g., x) and a second axis (e.g., y), that allows the device to specify positions in a plane.

An external storage device 1212 may be connected to the computer platform 1201 via bus 1204 to provide an extra or removable storage capacity for the computer platform 1201. In an embodiment of the computer system 1200, the external removable storage device 1212 may be used to facilitate exchange of data with other computer systems.

The invention is related to the use of computer system 1200 for implementing the techniques described herein. In an embodiment, the inventive system may reside on a machine such as computer platform 1201. According to one embodiment of the invention, the techniques described herein are performed by computer system 1200 in response to processor 1205 executing one or more sequences of one or more instructions contained in the volatile memory 1206. Such instructions may be read into volatile memory 1206 from another computer-readable medium, such as persistent storage device 1208. Execution of the sequences of instructions contained in the volatile memory 1206 causes processor 1205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1205 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1208. Volatile media includes dynamic memory, such as volatile storage 1206. Transmission media includes coaxial cables, copper wire and fiber optics, including the wires that comprise data bus 1204. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1205 for execution. For example, the instructions may initially be carried on a magnetic disk from a remote computer. Alternatively, a remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on the data bus 1204. The bus 1204 carries the data to the volatile storage 1206, from which processor 1205 retrieves and executes the instructions. The instructions received by the volatile memory 1206 may optionally be stored on persistent storage device 1208 either before or after execution by processor 1205. The instructions may also be downloaded into the computer platform 1201 via Internet using a variety of network data communication protocols well known in the art.

The computer platform 1201 also includes a communication interface, such as network interface card 1213 coupled to the data bus 1204. Communication interface 1213 provides a two-way data communication coupling to a network link 1214 that is connected to a local network 1215. For example, communication interface 1213 may be an integrated services digital network (ISDN) card or a modem to provide a data communication connection to a corresponding type of telephone line. As another example, communication interface 1213 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1213 sends and receives electrical, electromagnetic or optical signals that carry digital data streams representing various types of information.

Network link 1213 typically provides data communication through one or more networks to other network resources. For example, network link 1214 may provide a connection through local network 1215 to a host computer 1216, or a network storage/server 1217. Additionally or alternatively, the network link 1213 may connect through gateway/firewall 1217 to the wide-area or global network 1218, such as an Internet. Thus, the computer platform 1201 can access network resources located anywhere on the Internet 1218, such as a remote network storage/server 1219. On the other hand, the computer platform 1201 may also be accessed by clients located anywhere on the local area network 1115 and/or the Internet 1118. The network clients 1220 and 1221 may themselves be implemented based on the computer platform similar to the platform 1201.

Local network 1115 and the Internet 1118 both use electrical, electromagnetic or optical signals that carry digital data streams. The signals through the various networks and the signals on network link 1214 and through communication interface 1213, which carry the digital data to and from computer platform 1201, are exemplary forms of carrier waves transporting the information.

Computer platform 1201 can send messages and receive data, including program code, through the variety of network(s) including Internet 1218 and LAN 1215, network link 1214 and communication interface 1213. In the Internet example, when the system 1201 acts as a network server, it might transmit a requested code or data for an application program running on client(s) 1220 and/or 1221 through Internet 1218, gateway/firewall 1217, local area network 1215 and communication interface 1213. Similarly, it may receive code from other network resources.

The received code may be executed by processor 1205 as it is received, and/or stored in persistent or volatile storage devices 1208 and 1206, respectively, or other non-volatile storage for later execution. In this manner, computer system 1201 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with data replication functionality. It is intended that the specification and examples be considered as exemplary only, with a true scope and spirit of the invention being indicated by the following claims.

What is claimed is:

1. A computer-implemented method comprising:
a. Capturing at least a portion of a presentation given by a presenter;
b. Capturing at least a portion of actions of the presenter;
c. Using the captured actions of the presenter to analyze and identify a sequence of regions of interest in the presentation;
d. Using the captured actions of the presenter to identify the temporal path of the presentation; and
e. Composing a focused timed content representation of the presentation based on the identified sequence of regions of interest in the presentation and the identified the temporal path of the presentation, wherein the focused timed content representation focuses on the identified regions of interest in the presentation.

2. The method of claim 1, wherein the at least a portion of the captured actions of the presenter comprises words spoken by the presenter and wherein the regions of interest in the presentation are identified using a speech recognition performed on the words spoken by the presenter and the captured at least a portion of a presentation given by a presenter.

3. The method of claim 1, further comprising focusing on a next identified region of interest in the presentation upon a command from a user.

4. The method of claim 1, wherein the presentation comprises a bar graph and wherein the identified sequence of regions of interest in the presentation follows along a contour at a top of the bar graph.

5. The method of claim 1, wherein the presentation comprises a chart including a set of directional arrows and wherein the identified sequence of regions of interest in the presentation follow along the direction, indicated by the directional arrows.

6. The method of claim 1, wherein presentation comprises a chart including a plurality of elements each having set of mixed-directional arrows and wherein regions of interest in the identified sequence of regions of interest are ordered based on the number of arrows associated with each element of the plurality of elements.

7. The method of claim 1, wherein presentation comprises a table and wherein regions of interest in the identified sequence of regions of interest are identified by skimming the table along title and articles.

8. The method of claim 1, further comprising detecting a positional orientation of a device used by a user and displaying at least a portion of the presentation and wherein the sequence of regions of interest in the presentation is identified based on the detected positional orientation.

9. The method of claim 1, wherein the captured at least a portion of actions of the presenter comprises hand gestures of the presenter and wherein the sequence of regions of interest in the presentation is identified based on the captured hand gestures of the presenter.

10. The method of claim 1, wherein the captured at least a portion of actions of the presenter comprises a location or a direction of a pointing device of the presenter and wherein the sequence of regions of interest in the presentation is identified based on the captured location or direction of a pointing device of the presenter.

11. The method of claim 1, wherein the captured at least a portion of actions of the presenter comprises a notation made by the presenter on the presentation and wherein the sequence of regions of interest in the presentation is identified based on the captured notation made by the presenter on the presentation.

12. A computer-readable medium embodying a set of instructions, which, when executed by one or more processors cause the one or more processors to perform a method comprising:
a. Capturing at least a portion of a presentation given by a presenter;
b. Capturing at least a portion of actions of the presenter;
c. Using the captured actions of the presenter to analyze and identify a sequence of regions of interest in the presentation;
d. Using the captured actions of the presenter to identify the temporal path of the presentation; and
e. Composing a focused timed content representation of the presentation based on the identified sequence of regions of interest in the presentation and the identified the temporal path of the presentation, wherein the focused timed content representation focuses on the identified regions of interest in the presentation.

13. The computer-readable medium of claim 12, wherein the at least a portion of the captured actions of the presenter comprises words spoken by the presenter and wherein the regions of interest in the presentation are identified using a speech recognition performed on the words spoken by the presenter and the captured at least a portion of a presentation given by a presenter.

14. The computer-readable medium of claim 12, wherein the method further comprises focusing on a next identified region of interest in the presentation upon a command from a user.

15. The computer-readable medium of claim 12, wherein the presentation comprises a bar graph and wherein the identified sequence of regions of interest in the presentation follows along a contour at a top of the bar graph.

16. The computer-readable medium of claim 12, wherein the presentation comprises a chart including a set of directional arrows and wherein the identified sequence of regions of interest in the presentation follow along the direction, indicated by the directional arrows.

17. The computer-readable medium of claim 12, wherein presentation comprises a chart including a plurality of elements each having set of mixed-directional arrows and wherein regions of interest in the identified sequence of regions of interest are ordered based on the number of arrows associated with each element of the plurality of elements.

18. The computer-readable medium of claim 12, wherein presentation comprises a table and wherein regions of interest in the identified sequence of regions of interest are identified by skimming the table along title and articles.

19. The computer-readable medium of claim 12, wherein the method further comprises detecting a positional orientation of a device used by a user and displaying at least a portion of the presentation and wherein the sequence of regions of interest in the presentation is identified based on the detected positional orientation.

20. The computer-readable medium of claim 12, wherein the captured at least a portion of actions of the presenter comprises hand gestures of the presenter and wherein the sequence of regions of interest in the presentation is identified based on the captured hand gestures of the presenter.

21. The computer-readable medium of claim 12, wherein the captured at least a portion of actions of the presenter comprises a location or a direction of a pointing device of the presenter and wherein the sequence of regions of interest in the presentation is identified based on the captured location or direction of a pointing device of the presenter.

22. The computer-readable medium of claim 12, wherein the captured at least a portion of actions of the presenter comprises a notation made by the presenter on the presentation and wherein the sequence of regions of interest in the presentation is identified based on the captured notation made by the presenter on the presentation.

23. A computerized system comprising:
a. A capture module operable to capture at least a portion of a presentation given by a presenter and capture at least a portion of actions of the presenter;
b. A presentation analysis module operable to use the captured actions of the presenter to analyze and identify a sequence of regions of interest in the presentation and to use the captured actions of the presenter to identify the temporal path of the presentation; and
c. A video authoring module operable to compose a focused timed content representation of the presentation based on the identified regions of interest in the presentation and the identified the temporal path of the presentation, wherein the focused timed content representation focuses on the identified regions of interest in the presentation.

24. The computerized system of claim 23, further comprising at least one of a projector, a computer system of the presenter, a camera and a microphone operatively coupled to the capture module to capturing at least a portion of a presentation.

25. The computerized system of claim 23, further comprising a user device orientation detection interface operable to receive information on orientation of a user device.
